(19) United States
(12) Patent Application Publication
(10) Pub. No.: US 2021/0356064 A1
(43) Pub. Date: Nov. 18, 2021

(54) COUPLING ASSEMBLY WITH VALVES AND METHOD OF COUPLING

(71) Applicant: SELF ENERGISING COUPLING COMPANY LIMITED, Cheshire (GB)

(72) Inventor: Matthew Joseph Readman, Manchester (GB)

(21) Appl. No.: 17/286,920

(22) PCT Filed: Oct. 4, 2019
(86) PCT No.: PCT/GB2019/052807

§ 371 Date: Apr. 20, 2021

(30) Foreign Application Priority Data
Oct. 31, 2018 (GB) 1817833.5

(51) Int. Cl. F16L 37/34; F16L 37/096; F16L 37/35

(52) U.S. Cl. CPC F16L 37/34; F16L 37/35; F16L 37/096

(57) ABSTRACT

A valve assembly (10) comprising a male coupling member (100) and a female coupling member (200) which are connectable by inserting a probe (110) of the male member into a socket (210) of the female member. A fluid passageway (120) within the male member has an aperture (122) on the probe that is opened and closed by a second closing member. A fluid passageway (220) within the female member has an aperture (222) within the socket that is opened and closed by a first closing member (230) moveable within the socket. When mated, fluid flows between the two fluid passageways. The female member includes a first cage (240). During insertion of the probe into the socket, the first cage releasably locks the first closing member to the probe such that the cage carries separation forces created due to the pressure of the fluid within the fluid passageways.

### FIELD

The present disclosure relates in general to a coupling assembly and in particular, although not limited to, a valve assembly for opening and closing fluid passageways. The present disclosure further relates to a method of interconnecting a coupling assembly.

### BACKGROUND

It is a common requirement in many industries to be able to open and close fluid passageways. Fluid passageways require opening and closing in a variety of circumstances, for instance after the coupling or before the uncoupling of two fluid passageways (e.g. pipes or hoses). In applications where one or both of the fluid passageways contain pressurised fluid (e.g. during so-called “hot make” or “hot break” conditions), large separation forces may be exerted. Suitably, securing means may be provided to secure together those parts on which the separation forces act and to carry these separation forces during coupling and uncoupling.

In the international patent application WO 2008087457 A1, a particular example of such a securing means is described in the form of a clam-shaped cage. The cage is arranged such that coupling of two coupling members causes the cage to close and thus secure the coupling members together, while uncoupling causes the cage to open and thus release the coupling members. In order to open the cage, the coupling member which is withdrawn from the cage forms a pair of ramp-like features arranged to cause the cage to open during uncoupling. The ramp-like features are arranged in an arrowhead configuration, causing the clam-shaped cage to be forced open as the coupling members are uncoupled.

Notably, the clam-shaped cage engages the arrowhead configuration to secure the coupling assembly. The arrowhead configuration, therefore, is arranged to be retained by the cage against separation forces acting along the coupling axis as well as arranged to cause the opening of the cage along an axis perpendicular to the coupling axis. In order to achieve both these purposes, the chamfered shoulders of the arrowhead configuration are at an angle to both axes. This, however, increases a strain on the cage which may, after repeated uncoupling, lead to a deformation of the cage which may affect operation of the coupling assembly.

Therefore, it is now desired to provide a coupling assembly as an alternative to previously available designs. The example embodiments have been provided with a view to addressing at least some of the difficulties that are encountered with current coupling assemblies whether those difficulties have been specifically mentioned above or will otherwise be appreciated from the discussion herein.

### SUMMARY

It is an object of the present invention to overcome at least one of the above or other disadvantages. It is an aim of the present invention to provide a coupling assembly arranged to better withstand repeated coupling and uncoupling.

In the example embodiments a cage, which is arranged to carry separation forces, is closed and opened by a cam and follower arrangement. By constricting the opening and closing motion through the cam and follower arrangement, the cage can be opened and closed about a coupling member without relying on an oblique reaction force acting on the cage and the coupling member. In the exemplary embodiments, the cage and coupling member abut on a surface orthogonal to the coupling axis. The cage carries the separation forces in tension without the oblique reaction force.

According to an example, there is provided a coupling assembly having a female coupling member and a male coupling member. The female coupling member includes a securing member arranged to releasably secure the male coupling member. Suitably, the coupling assembly includes a follower and a track along which the follower is displaceable. Conveniently, displacing the follower along the track causes the securing member to move towards, i.e. secure, the male coupling member during coupling and, during uncoupling, causes the securing member to move away from, i.e. release, the male coupling member.

According to an exemplary embodiment, there is provided a valve assembly having a female coupling member and a male coupling member wherein: A valve assembly having a female coupling member and a male coupling member, the male member comprising: a probe, and a first fluid passageway having a first exit aperture on a side face of the probe; and the female coupling member comprising: a socket for receiving a probe of the male coupling member along a coupling axis, a second fluid passageway having a second exit aperture on an internal side face of the socket, a first closing member which is freely moveable between an open position in which the exit aperture of the socket is at least partially unobstructed and a closed position in which the exit aperture is fully obstructed, a first securing member which is pivotally connected to a first pivot moveable with the closing member and defining a first pivot axis; a first follower which is mounted to a first track and arranged to be displaced along the first track by the first securing member to cause the first securing member to pivot relative to the first closing member to releasably secure the first closing member to the probe such that the first closing member and the probe are restrained from moving relative to each other.

Preferably the valve assembly is opened and closed by coupling the male and female members. During coupling the socket may receive the probe by relative movement along a first direction. The members may be uncoupled by relative movement along a second direction, the second direction being opposed to the first. Insertion of the probe into the socket may cause the first closing member to move towards its open position. The first closing member may be caused to move towards its open position by abutment between the probe and the closing member. The abutment may be between distal ends of the probe and the closing member.

Preferably the movement of the first closing member towards the open position may cause the first securing member to engage the probe. Additionally movement of the first closing member towards the closed position may cause the first securing member to disengage the probe. The first securing member may comprise two parts wherein at least one of the parts is pivotal towards or away from the other in order to engage and disengage the probe. Preferably both parts may be pivotally moveable towards and away from each other. The two parts may be biased away from each other in order to be biased towards the disengaged arrangement. The two parts may be biased by an elastic member arranged between the two parts. The elastic member may be a spring. Alternatively, the two parts may be biased by a resilient member that is attached to the distal ends of the two parts. The resilient member may be a coil spring.

Preferably the pivot axis of the first securing means is locked fast with respect to the first closing member. Accordingly as the closing member is caused to move by insertion of the probe into the socket, the first securing means is caused to move with it.

Preferably the male member includes a second closing member arranged about the probe. The second closing member may be moveable between an open position in which the or each exit aperture of the probe is at least partially unobstructed and a closed position in which the or each exit aperture of the probe is fully obstructed. The second closing member may be freely moveable.

Preferably freely moveable means that the closing member is unbiased towards its closed position.

In some examples, the male coupling member includes a second closing member arranged about the probe, wherein the second closing member is movable between an open position in which the second exit aperture is at least partially unobstructed and a closed position in which the second exit aperture is fully obstructed.

Preferably the female member includes a second securing means for releasably securing the socket to the second closing member in order to restrict relative movement between said socket and second closing member. Preferably during coupling the second securing means may restrict relative movement between the second closing member and the socket before the or each exit aperture of the probe is opened.

Additionally, during uncoupling the second securing means may restrict relative movement between the second closing member and socket until after the or each exit aperture of the socket is closed. The securing means may restrict the second closing member from moving relative to the socket such that the second closing member closes the or each aperture in the probe before the second securing means releases the second closing member and any forces that are generated by the coupling/uncoupling of the members and that act to urge the second closing member away from the socket are carried by the second securing means. The second securing means may lock the second closing member to the socket. The exemplary embodiment thereby enables the male and female member to be coupled and uncoupled without fluid within the or each first and second passageways being lost since the member cannot be uncoupled without the first and second closing members being in their respective closed positions.

In some examples, the female coupling member comprises a second securing member which is pivotally connected to a second pivot defining a second pivot axis, and a second follower which is mounted to a second track and arranged to be displaced along the second track by the first securing member to cause the second securing member to pivot relative to the socket to releasably secure the socket to the second closing member such that the socket and the second closing member are restrained from moving relative to each other.

Preferably the second securing member is arranged inside the first securing member. Suitably, the second securing member may comprise the second follower and the second track may be formed on an internal side face of the first securing member. Alternatively, the first securing member may comprise the second follower and the second track may be formed on a side of the second securing member.

Preferably the second track comprises a straight section.

Preferably the second securing member may be caused to engage the second closing member by movement of the first securing member towards an engaged position. Additionally the second securing means may be cause to disengage the second closing member by movement of the first securing means away from the engaged position. The second securing means may be slidable relative to the first securing means. The second securing means may comprise two parts which are pivotal towards and away from each other. The two parts may be biased away from each other in order to be biased towards the disengaged arrangement. The two parts may be biased by the elastic member arranged to bias the first securing member.

Preferably the first track along which the first follower is displaceable comprises a plurality of sections. Displacement along a first section of the first track may bring the first securing member from an unlocked configuration into a locked configuration in which the first securing member is arranged to engage the probe. Suitably, displacement along the first section may cause the first securing member to pivot about the socket so that, during insertion of the probe, the first securing member may engage the probe. Displacement along a second section of the first track may cause the first securing member to follow the probe as the probe is being inserted farther into the socket. Suitably, displacement along the second section may cause the first securing member to shift parallel to the coupling axis. Conveniently, the first securing member remains in the locked configuration as it follows the probe.

In some examples, the first follower is displaceable along a first section of the first track to pivot the first securing member, and the first follower is displaceable along a second section of the first track to shift the first securing member parallel to the coupling axis.

Preferably the first track is arranged to form a V-shape. Suitably, the first section and the second section of the first track may meet at angle. Additionally, the first section and the second section may each be substantially straight. Conveniently, each section of the first track may have a length suitable for operation of the coupling assembly. Accordingly, the V-shape may not be symmetrical. It is also envisaged for sections of the first track to be arranged in other shapes, such as a C-shape.

In some examples, the first section of the first track and the second section of the first track are arranged in a V-shape.

Preferably the first securing member comprises the first follower. That is, the first follower may form part of the first securing member. Suitably, the track along which the first follower is displaceable is formed in a rigid structure being part of the female coupling member. Conveniently, the first track is formed in a housing of the female coupling member.

Preferably, the first track is extends along a plane which is perpendicular to the coupling axis.

Preferably the first track is formed in the housing or other rigid structure of the female member while the first follower is arranged on the first securing member. It is also envisaged for the first follower to be arranged on the housing or other rigid structure while the first track is formed in the first securing member.

In some examples, the first follower is located on the first securing member and the first track is formed in a housing of the female coupling member.

Preferably the first securing member extends between the pivot axis defined by the first pivot and a rotation axis defined by the first follower. The first securing member may thus be particularly suitable for withstanding forces exerted during coupling or uncoupling. Suitably, the first securing member may comprise a straight section extending continuously between the first pivot axis and the rotation axis. It is also envisaged that the first securing member may not be straight or continuous. In some cases, the first securing member may be neither straight nor continuous. For example, there may be additional portions making the first securing member not straight and/or there may be apertures so that the first securing member does not continuously extend between the pivot axis and the rotation axis.

Preferably the first securing member may be perpendicular to both the pivot axis and the rotation axis.

In some examples, the first securing member is arranged to occupy a space which extends between the first pivot axis and an axis of rotation defined by the first follower.

Preferably the second closing member is restricted to motion between the open configuration and the closed configuration. Suitably, the male coupling member may comprise a shaft arranged to restrict motion of the second closing member. Conveniently, the shaft may be arranged to restrict the second closing member to motion along one axis. Suitably, the second closing member may comprise the shaft, which may be mounted in a passage extending parallel to the coupling axis. Rotation of the closing member may thus be prevented, particularly where coupling is possible only in a limited number of orientations.

In some examples, the male coupling member comprises: a passage extending parallel to the coupling axis and is arranged to receive a shaft, the shaft arranged moveable with the second closing member and constrained to motion along the passage.

Preferably the shaft is arranged to restrict the second closing member to motion between two extremal positions. Suitably, the shaft may be hindered from fully leaving the passage. Conveniently, the open position may correspond to a first extremal position and the closed position may correspond to a second extremal position.

Preferably the valve assembly is arranged so that fluid trapped between the female coupling member and the male coupling member is drained through a drainage passageway during coupling. Suitably, a third fluid passageway may be provided. The third fluid passageway may have a third exit aperture in a distal end face of the second closure member, and the third fluid passageway may extend through the shaft. Fluid trapped during coupling between the distal end face of the second closure member and the female coupling member may thus flow into the third exit aperture and through the third fluid passageway. A suitable exit aperture may be provided to release said fluid.

In some examples, the male coupling member comprising a third fluid passageway which extends between an exit aperture in a distal end face of the second closure member and exit aperture in the shaft.

Preferably the shaft is arranged to prevent the second closure member from leaving the closed position in which the second exit aperture is fully obstructed. For example, the shaft and the passage may be arranged so that additional force is required to move the shaft past a certain point.

In some examples, the shaft is configured so that the second closure member is biased towards the closed position in which the second exit aperture is fully obstructed.

In some examples, the male coupling member comprises a projection on a distal end face of the probe; the female coupling member comprises a recess formed in a distal end face of the first closure member and arranged to receive the projection of the probe.

Preferably the valve assembly is arranged so that fluid trapped between the probe and the first closure member is drained through a drainage passageway during coupling. Suitably, a fourth fluid passageway may be provided. The fourth fluid passageway may have a fourth exit aperture in a distal end face of the first closure member, and the fourth fluid passageway may extend through the first closure member. Suitably, the fourth exit aperture may be formed in a distal end face of the first closure member. Conveniently, where a recess is provided in the first closure member the fourth exit aperture may be formed in the recess.

In some examples, the female coupling member comprises a fourth fluid passageway having a fourth exit aperture in the recess of the first closure member; the fourth fluid passageway extending through the first closure member.

Preferably the pivot axis of the second securing means is locked fast with respect to the socket. Accordingly as the probe is inserted into the socket the second closing member is caused to move towards its open position by abutment between the socket and closing member. Additionally as the probe is withdrawn from the socket, the second closing member is caused to move towards its closed position by the engagement of the second closing means.

Preferably the coupling members may be uncoupled by withdrawing the probe from the socket. When the probe is inserted in the socket the or each exit aperture in the probe's side face may be coincident with the or each exit aperture in the socket's internal face.

Preferably the female member may include alignment features to cooperate with features on the male member in order to ensure the correct alignment of the probe in the socket. The alignment features may include a protrusion and a corresponding slot in one of the male or female members respectively. The slot may be formed when an upper first securing member and a lower first securing member are brought into a closed configuration. The slot may extend between the upper and the lower first securing member. Suitably, the slot may be arranged to receive a projection of the male coupling member.

Preferably each closing member may include two sealing rings such that, when in their closed positions the sealing rings create a seal on either side of each aperture. The seals on each closing member may be the same size such that, when coupled and pressurized, no net separation force is generated.

When the male and female couplings include multiple fluid passageways, each passageway in the female member may include its own socket. Each socket may be closed by a closing member. Each closing member may be connected to the other so that the sockets are open and closed simultaneously. The male member may include a probe for each passageway. The probes may be connected to each other. A single closing member may close each of the probes.

Preferably the coupling members may be arranged such that the second closing member is returned to a distal end of the probe during uncoupling. Suitably, the second closing member comprises a latch arranged to resist uncoupling until the second closing member is returned to the distal end of the probe. During uncoupling, as the male coupling member is moved along the coupling axis, the latch may catch the female coupling member and thus resist uncoupling. Suitably, thereby the second closing member may be retained in position as the probe is withdrawn so that relative movement between the second closing member and probe is caused. Thereby the second closing member may be displaced to the distal end of the probe. Once the second closing member is returned to the distal end of the probe, the second closing member may be located in an extremal distal position relative to the probe. That is, the second closing member may be arranged to resist further displacement of the second closing member past the distal end of the probe. As such, the latch may be urged against the female coupling member with increasing force during uncoupling and eventually urged into a retracted configuration. Suitably, in the retracted configuration the second closing member is removable from the female coupling member.

The latch may be arranged to engage any suitable portion of the female coupling member. For example, the latch may be arranged to engage the second securing member. In other examples, the latch may be arranged to engage socket.

Conveniently, the latch is biased to return to the extended configuration, thus enabling convenient repeated coupling and decoupling. Any suitable biasing means may be used. For example, the latch may be sprung. In some examples, the latch may be mounted rotatable about a pivot axis, and a spring arranged to cause a rotation about the pivot axis.

In some examples, the second closing member comprises a latch which is moveable between an extended configuration and a retracted configuration, the latch being biased towards the extended configuration in which the latch is arranged to engage the female member during uncoupling, the latch being arranged to move to the retracted configuration as the second closing member is urged against the female member during uncoupling, and the second closing member being removable from the female member when the latch is in the retracted configuration.

In some examples, there is provided a female coupling member for use with a male coupling member, as described above.

According to an exemplary embodiment, there is provided a female coupling member for use with a male coupling member in a valve assembly, the female coupling member comprising: a socket for receiving a probe of said male coupling member along a coupling axis; a second fluid passageway having a second exit aperture on an internal side face of the socket; a first closing member which is freely moveable between an open position in which the second exit aperture is at least partially unobstructed and a closed position in which the second exit aperture is fully obstructed; a first securing member which is pivotally connected to a first pivot moveable with the closing member and defining a first pivot axis; a first follower which is mounted to a first track and arranged to be displaced along the first track to cause the first securing member to pivot relative to the first closing member.

Preferably the female coupling member includes any of the features described above in relation to the female coupling member as part of the valve assembly.

According to an exemplary embodiment, there is provided a male coupling member for use with a female coupling member in a valve assembly, the male coupling member comprising: a probe for insertion into a socket of said female coupling member along a coupling axis, and a first fluid passageway having a first exit aperture on a side face of the probe.

Preferably the male coupling member includes any of the features described above in relation to the male coupling member as part of the valve assembly.

According to an exemplary embodiment, there is provided a method of releasably interconnecting a female coupling member and a male coupling member of a coupling assembly. The method comprises: inserting a probe of the male member into a socket of the female member, the probe including a first fluid passageway having a first exit aperture on a side face of the socket, the socket including a second fluid passageway having a second exit aperture on an internal side face of the socket; displacing a first closing member which is moveable between an open position in which the first exit aperture is at least partially unobstructed and a closed position in which the exit aperture is fully obstructed; causing a displacement of a first securing member, the first securing member being pivotally connected to a first pivot moveable with the first closing member and defining a first pivot axis; and causing a follower mounted to a first track to be displaced along the first track to cause pivoting of the first securing member relative to the first closing member to releasably secure the first closing member to the probe such that the first closing member and the probe are restrained from moving relative to each other.

Preferably the method comprises causing a second securing means of the female member to releasably secure a second closing member of the male coupling member, said second closing member being moveable between an open position in which the or each exit aperture of the probe is at least partially unobstructed and a closed position in which the or each exit aperture is fully obstructed, to the socket when both the closing member are in closed positions.

Preferably the method comprises coupling the coupling members as herein described.

In some examples, there is provided a male coupling member for use with a female coupling member, as described above.

### BRIEF DESCRIPTION OF DRAWINGS

For a better understanding of the invention, and to show how example embodiments may be carried into effect, reference will now be made to the accompanying drawings in which:

FIG. 1 is a perspective view of a coupling assembly in a coupled arrangement;

FIG. 2 is a perspective, partially cut-away side view of coupling assembly in a coupled arrangement;

FIG. 3 is a perspective, partially cut-away side view of a coupling assembly in an uncoupled arrangement;

FIG. 4 is a cut-away side view of a coupling assembly in a coupled arrangement;

FIG. 5 is a cut-away side view of a coupling assembly in a partially coupled arrangement;

FIG. 6 is a perspective, partially cut-away side view of a female coupling member;

FIG. 7 is a partially cut-away side view of a housing of a female coupling member;

FIG. 8 is perspective side view of a male coupling member;

FIG. 9 is a partially cut-away side view of a male coupling member;

FIG. 10 is a perspective, cut-away top view of a coupling assembly in a partially coupled arrangement;

FIG. 11 is a perspective, cut-away top view of a coupling assembly in a partially coupled arrangement;

FIG. 12 is a perspective, cut-away top view of a coupling assembly in a partially coupled arrangement;

FIG. 13 is a perspective, partially cut-away side view of a coupling assembly in an uncoupled arrangement;

FIG. 14 is a perspective, partially cut-away side view of a coupling assembly in a coupled arrangement;

FIG. 15 is a perspective side view of a coupling assembly in a coupled arrangement;

FIG. 16 is a perspective, partially cut-away side view of a coupling assembly in a coupled arrangement; and

FIG. 17 is a perspective, partially cut-away side view of a coupling assembly in an uncoupled arrangement.

### DESCRIPTION OF EMBODIMENTS

At least some of the following example embodiments provide an improved valve assembly. The example devices are durable and arranged to withstand repeated coupling and uncoupling. The example devices are arranged for reduced fluid loss when coupling and uncoupling. The example devices are easy to actuate and particularly suitable for actuation through robots. Many other advantages and improvements will be discussed in more detail herein.

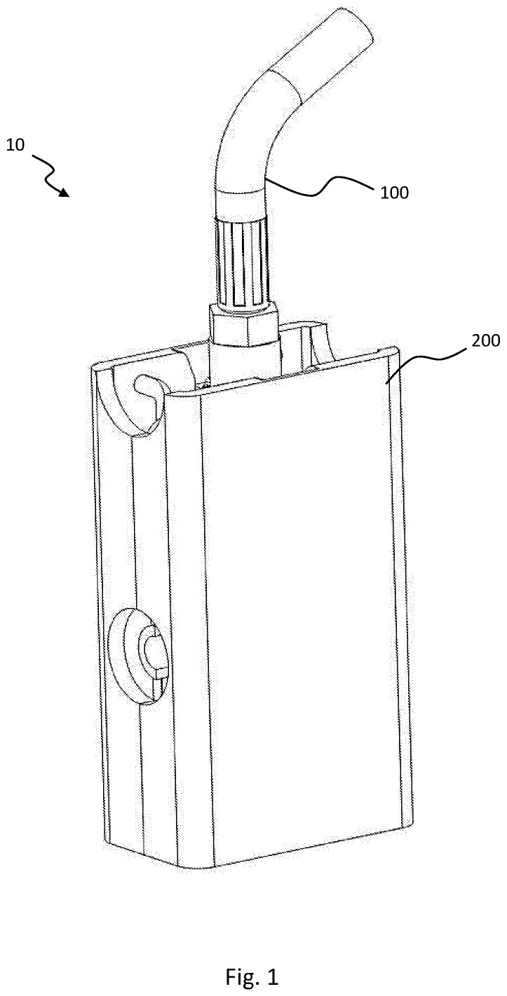

FIG. 1 is a perspective side view of a valve assembly 10 in a coupled arrangement.

The valve assembly is arranged for releasably coupling, i.e. coupling and uncoupling. Suitably, the valve assembly comprises a pair of coupling members consisting of a male coupling member 100 and a female coupling member 200. The male member 100 can be coupled to the female member 200 by relative movement along a coupling axis. That is, coupling is effected by relative linear motion. Notably, linear motion is easy to actuate using robots.

The female coupling member 200 is arranged to receive and engage the male coupling member 100 so that they may be coupled together. The female coupling member is also arranged to release the male coupling member so that they may be uncoupled.

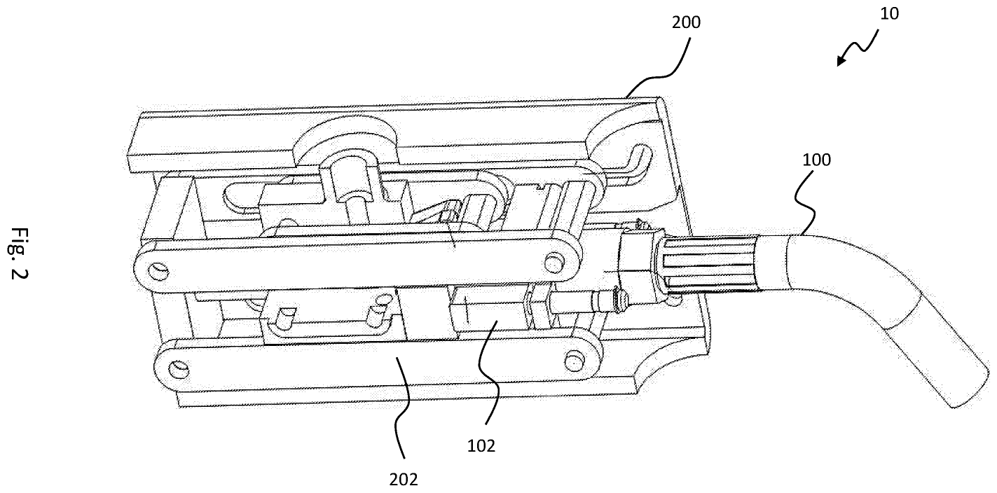

FIG. 2 is a partial cut-away side view of the valve assembly 10 in a coupled arrangement.

The male member 100 includes a body 102 arranged for insertion into the female coupling member 200 and to couple thereto. Suitably, the female coupling member includes a body 202 arranged to receive and engage the body of the male coupling member.

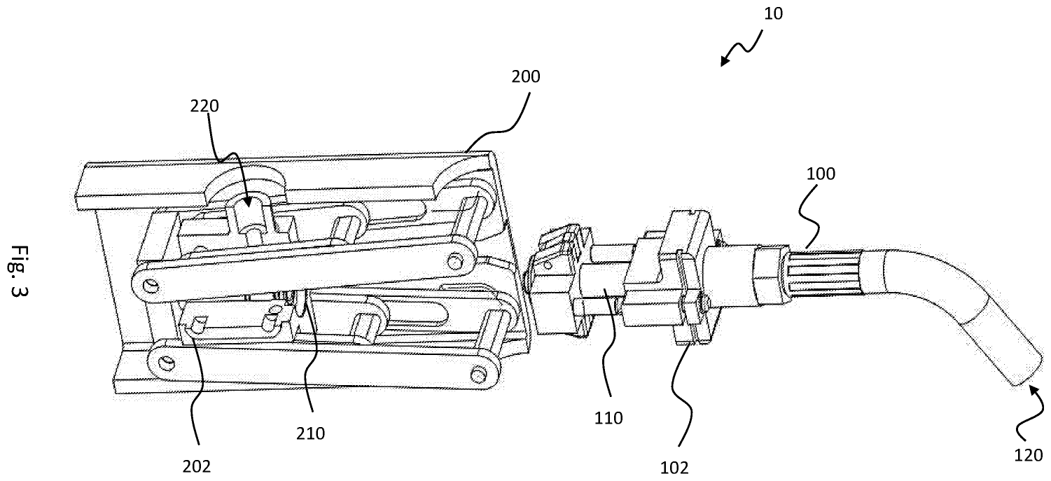

FIG. 3 is a perspective side view of the male coupling member 100 and a partial cut-away perspective side view of the female coupling member 200.

The male coupling member 100 comprises a probe 110 projecting from the body 102. The probe has a shape suitable for insertion into a socket of the female coupling member. For example, the probe may be a projection having a circular, oval or polygonal cross-section. The cross-section may be substantially constant along the probe. In this example, the probe is a projection having a circular cross-section which is substantially constant, resulting in a cylindrical overall form.

The body 202 of the female coupling member 200 is arranged to receive the probe 110. Suitably, the body forms a socket 210 for receiving the probe 110. The socket is a recess having a shape corresponding to that of the probe. In this example, the probe being cylindrical, the socket is a generally cylindrical recess arranged to receive the probe.

When the coupling assembly 10 is in a coupled arrangement, fluid may flow between the male coupling member 100 and the female coupling member 200. Suitably, a first fluid passageway 120 extends through the male coupling member 100 and, in particular, through the probe 110. Similarly, a second fluid passageway 220 extends through the female member 200 and, in particular, to the socket 210. Conveniently, the first fluid passageway and the second fluid passageway are arranged to be in flow communication when the probe is received by the socket.

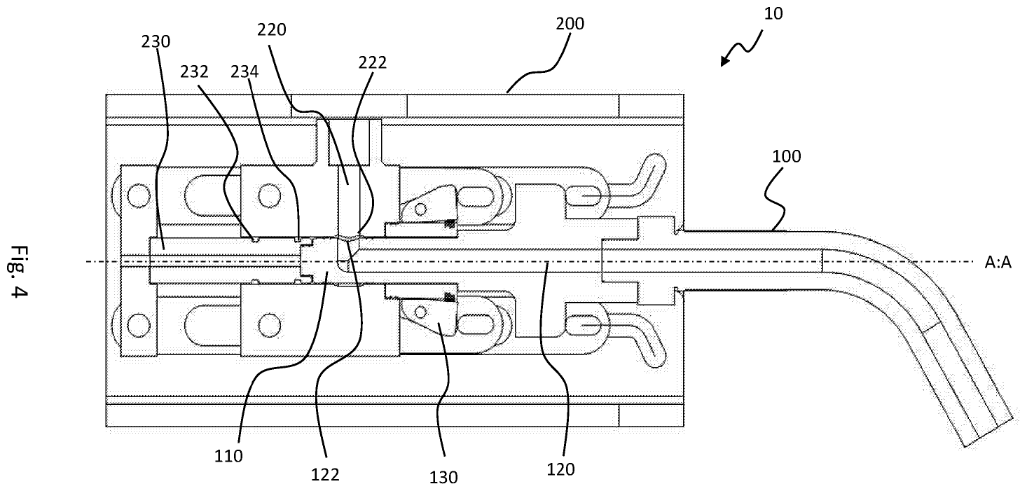

FIG. 4 shows a cut-away side view of the coupling assembly 10 in a coupled arrangement.

The first fluid passageway 120 extends through the probe 110 from a first exit aperture 122 arranged on a circumferential face of the probe. In use, fluid may flow into the first fluid passageway through the first exit aperture or flow out of the first fluid passageway through the first exit aperture.

The male coupling member 100 is arranged to prevent unwanted fluid flow through the passageway 120. Suitably, the probe 110 is provided with a sheath 130 for selectively restricting fluid flow. In this example, the sheath encloses the probe and is slidably mounted thereto. The sheath is slidable between an open position, in which the sheath does not restrict the first exit aperture 122, and a closed position (shown in FIG. 3), in which the sheath restricts fluid egress from the aperture.

A second fluid passageway 220 extends through the female member 200 from a second exit aperture 222 arranged on an internal circumferential face of the socket 210.

The female coupling member 200 is arranged to prevent unwanted fluid flow through the passageway 220. Suitably, the female coupling member comprises a piston 230 which is mounted within the socket 210. The piston is unbiased and free to slide between an open position, in which the piston does not restrict the second exit aperture 222, and a closed position (shown in FIG. 3) in which the piston restricts fluid egress from the aperture.

Suitably, the piston 230 is provided with a pair of sealing rings 232, 234 located in annular grooves extending circumferentially around the piston. When the piston is in the closed position, a first or proximal sealing ring 232 is located to the proximal side of the exit aperture 222, while a second or distal sealing ring 234 is located on the distal side of the exit aperture. Any pressure due to fluid in the second fluid passageway 220 acts on both sealing rings 232, 234 and, because the sealing rings are substantially identical and located on either side of the exit aperture, a zero net force is exerted on the piston in its closed position. Accordingly, the exit aperture remains closed.

As shown in FIG. 3, when uncoupled the sheath 130 and piston 230 are in their closed positions. Accordingly, pressurised fluid in the fluid passageways 120, 220 is restricted from egressing through the respective apertures 122, 222 due to the sheath and piston being in closed positions.

The male member 100 can be coupled to the female member 200 by relative movement of the probe 110 toward the socket 210 along the coupling axis A:A.

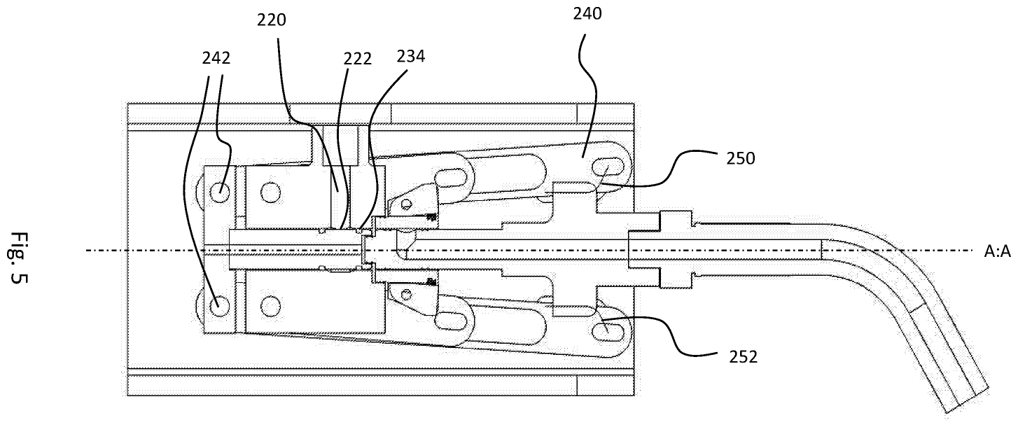

FIG. 5 shows the valve assembly 10 in an intermediate coupled configuration, wherein a distal end of the probe 110 abuts a distal end of the piston 230, and a distal end of the socket 210 abuts a distal end of the sheath 130.

In the intermediate coupled configuration of FIG. 5, the piston 230 is not displaced from its closed position but would be displaced once the probe 110 is inserted farther. Upon further insertion, the distal sealing ring 234 reaches the first exit aperture 222 and a separation force is exerted on the piston and the probe by pressurised fluid in the fluid passageway 220. The force on the piston is to urge the piston 230 towards the open position, and the force on the probe is to eject the probe 210 from the socket 210. Suitably, the female coupling member 200 comprises an outer cage 240 arranged to keep the piston and the probe together.

The outer cage 240 is arranged to engage the male coupling member 100 when the male and female coupling members are being coupled. Suitably, the outer cage is arranged to secure the probe 110 and the piston 230 together as the probe is inserted into the socket 210 and urged against the piston. Conveniently, the outer cage secures probe and piston prior to the distal sealing ring 234 reaching the first exit aperture 222, i.e. prior to the probe and the piston being forced apart by fluid pressure.

Suitably, the outer cage 240 is pivotally arranged about the piston 230. Conveniently, the outer cage is arranged such that the probe urging the piston out of its closed position causes the outer cage to enter a closed configuration in which the probe is secured.

The outer cage 240 is pivotally connected to a first pivot 242 moveable with the piston 230. The first pivot may be any suitable coupling, such as a pivot joint or pivot hinge. Further, the outer cage is arranged so that it is caused to pivot as the piston is displaced from its closed position towards its open position. Suitably, a follower 244 of the outer cage is mounted to a first track 250.

The follower 244 may be any member suitable for being mounted to a track and being moveable along the track. For example, the follower may be roller. In this example, the follower is a projection extending into a track 250. Accordingly, the follower is slidably mounted to the track.

The first track 250 comprises a first section 252 along which the follower 244 is displaceable to cause the outer cage 240 to pivot relative to the socket 210. Conveniently, the first track is arranged so that the outer cage is pivoted as the piston 230 is being displaced from its closed position towards its open position. Suitably, the first section 252 guides the follower 244 towards the coupling axis A:A.

The outer cage 240 is arranged to be in its closed configuration as the distal sealing ring 234 reaches the second exit aperture 222. Thereby it is ensured that the outer cage has closed about the male coupling member 100 so that a separation force exerted by pressurised fluid in the second fluid passageway 220 is carried by the outer cage 240. A zero net separation force results so that even where pressured fluid is present in the fluid passageways, the probe 110 and the piston 230 are restrained from moving relative to each other.

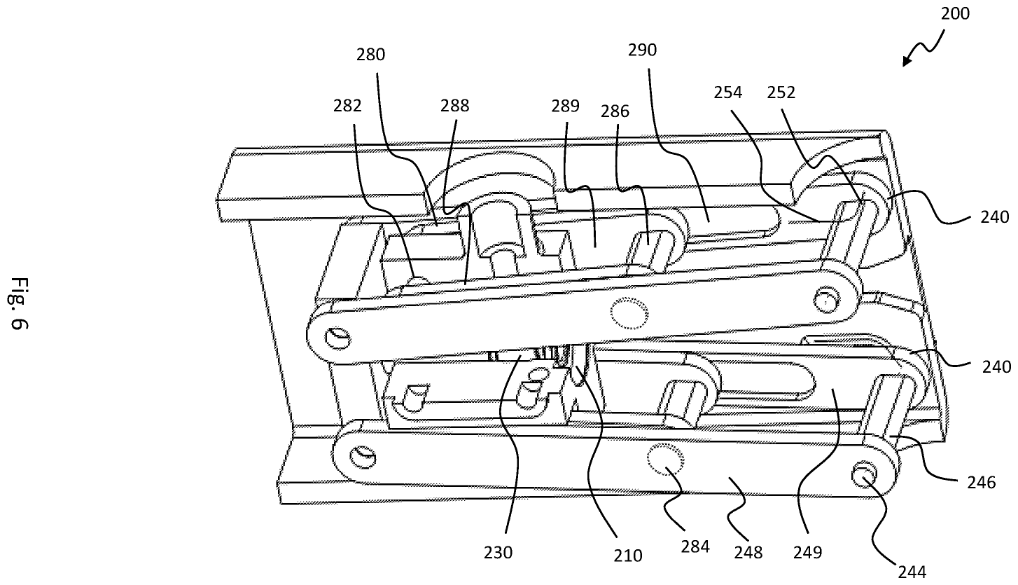

FIG. 6 is a perspective, partial cut-away side view of the female coupling member 200.

In response to insertion of the probe 110 into the socket 210, the outer cage 240 is brought into its closed configuration. Conveniently, in the closed configuration the outer cage carries any separation forces acting to expel the probe from the socket.

As the probe 110 is inserted farther into the socket 210, the outer cage 240 continues to carry any separation forces. Suitably, the outer cage is displaceable in its closed configuration to follow the probe and the piston 230. Suitably, the first track 250 comprises a second section 254 along which the first follower 244 is displaceable to move the outer cage in the closed configuration.

In this example, the outer cage 240 is brought into its closed configuration after having been displaced along the first section 252 of the track. Accordingly, the outer cage may be shifted to follow the piston 230 without requiring additional pivoting of the outer cage. Suitably, the second section 252 of the track extends parallel to the coupling axis A:A. Hence, the second section is arranged so that as the first follower 244 is displaced along the second section, the outer cage is shifted without causing the outer cage to pivot further.

As the outer cage 240 continues to be shifted with the piston 230 in response to the probe 110 being inserted into the socket 210, the outer cage continues to secure the probe to the piston.

The outer cage comprises a crossbar 246 arranged to engage an outer shoulder 104 of the male coupling member 100. Conveniently, the crossbar is shaped for improved rigidity. For example, the crossbar may have an oval or elliptical cross-section so as to better withstand forces acting along the major axis of the crossbar. In this example, the crossbar extends between a first side member 248 and a second side member 249 of the outer cage.

In this example, the follower 244 is formed integrally with the crossbar 246. Suitably, the follower and crossbar may be formed integrally using an elongate member, such as shaft or pole. Conveniently, the follower and/or the crossbar may be reinforced to withstand repeated coupling and uncoupling.

Conveniently, uncoupling of the male and female coupling members 100, 200 causes the outer cage 240 to enter its opened configuration. As the male coupling member is withdrawn from the female coupling member, the male coupling member pushes against the crossbar 246 of the outer cage. Accordingly, the outer cage is urged along the second section 254 of the track, in the direction of the uncoupling. As the outer cage is connected to the first pivot 246, which is moveable with the piston 230, this causes the piston to be displaced in response to the first pivot being displaced. Consequently, during withdrawal of the male coupling member the outer cage 240 continues to keep the probe 110 and the piston 230 together.

As the male coupling member continues to be withdrawn, the crossbar 246 is urged further. This eventually causes the first follower 244 to be displaced along the first section 252 of the track. As the first follower is displaced along the first section of the track along the direction of withdrawal, the outer cage is caused to pivot away from the piston 230 until the male coupling member 100 is released. Conveniently, the outer cage is caused to release the male coupling member once the exit aperture 222 is sealed by the piston. That is, the distal sealing ring 234 will have passed the second exit aperture and located on its distal side.

Accordingly, during uncoupling the male coupling member 100 urges against the crossbar 246 and hence displaces the outer cage 240 along the direction of uncoupling. As the outer cage is being urged into the direction of uncoupling, the first follower 244 is displaced along the first track 250 to cause the outer cage to enter its opened configuration. During uncoupling, motion of the outer cage along the axis of coupling is caused by the male coupling member pushing against it. By contrast, motion of the outer cage along a non-coupling axis direction, i.e. the pivoting of the outer cage, is caused by the first follower being displaced along the first track.

During insertion of the probe 110 into the socket 210, the first exit aperture 122 transitions from the sheath 130 into the socket. During this transition, the sheath may be displaced by pressurised fluid egressing from the first and/or second exit aperture, resulting in an unwanted egression of fluid. Suitably, the female coupling member comprises an inner cage 280 arranged to secure the sheath. The inner cage is pivotally arranged about the socket 210 so that, in use, the inner cage may secure the sheath 130 of the male coupling member 100 during insertion of the probe 110.

The inner cage 280 is pivotally connected to a second pivot 282 defining a second pivot axis. Suitably, the second pivot connects the inner cage to the body 202 of the female coupling member 200. Accordingly, the inner cage may pivot relative to the socket 210. In this example, the second pivot axis is parallel to the first pivot axis and perpendicular to the coupling axis A:A.

Pivoting of the inner cage 280 is caused by a second follower 284 being displaced along a second track 290. In this example, the second track is formed inside the outer cage 240. Conveniently, the second track is formed in the side member 246, 248. Suitably, the inner cage is mounted inside the outer cage, i.e. between the side members.

The second follower 284 is mounted to the second track 290 and displaceable along the second track when the inner cage 280 and the outer cage 240 are subjected to relative movement. During insertion of the male coupling member 100, the outer cage 240 is displaced relative to the body 202. This causes the outer cage as well to be displaced relative to the inner cage, which is pivotally joined to the body 202.

In this example, the second track 290 is straight and extends between the first pivot axis and the axis of rotation defined by the first follower 244. Suitably, the outer cage 240 occupies a space between the first pivot axis and the axis of rotation of the first follower. Conveniently, the second track delimits motion of the second follower from below and from above, hence causing the second follower to move up and to move down during uncoupling and coupling.

In other examples, the second track 290 is formed by the inner cage 240 and the second follower 284 formed by the outer cage 240.

As the outer cage 240 is caused to pivot relative to the socket 210, the inner cage 280 is also caused to pivot relative to the socket. With the first follower 242 being displaced along the first section 252 of the first track 250, which causes the outer cage to pivot, the second follower 284 is subjected to the pivoting motion of the outer cage as the second follower is displaced along the second track. The inner cage, therefore, is caused to pivot towards the coupling axis as the outer cage is caused to pivot towards the coupling axis. Accordingly, the inner cage assumes a closed configuration.

In the closed configuration the inner cage 280 engages the sheath 130. Suitably, the inner cage comprises an inner crossbar 286 arranged to engage the shoulder 135 of the sheath 130. In this example, the inner crossbar extends between a pair of inner side members 288, 289. During coupling, the inner crossbar retains the sheath in position against any separation force that may act on the sheath.

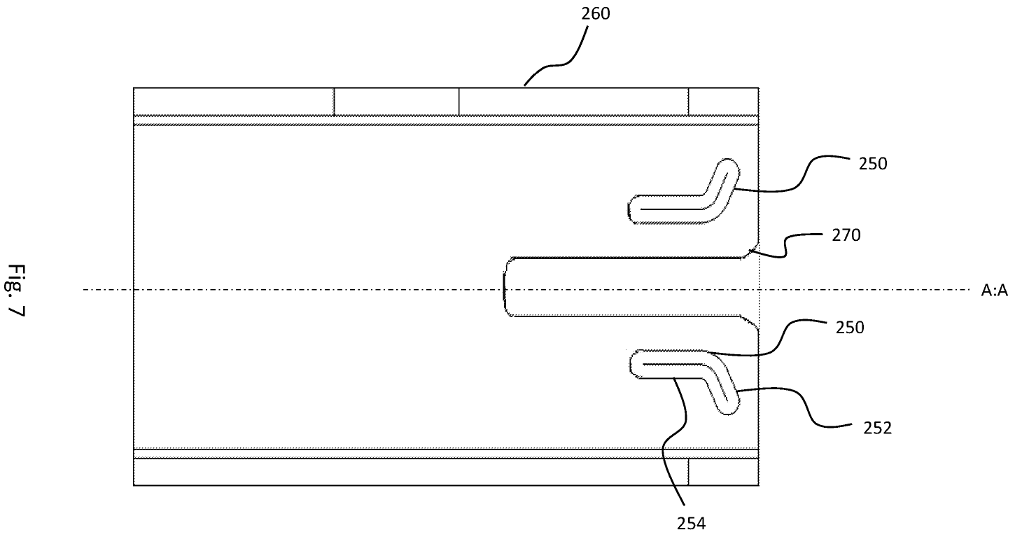

FIG. 7 is a partial cut-away side view of a housing of the female coupling member showing the first track 250.

The first track 250 is formed in a sufficiently rigid structure to receive the follower 244 and to cause the outer cage 240 to pivot as the follower is displaced along the track. Suitably, the first track is formed in a housing 260 of the female coupling member 200. Alternatively, the first track may be formed in any other sufficiently rigid structure.

In this example, the first track 250 is a recess or channel extending through the housing 260. Accordingly, the first follower 244 is moveable along or inside the first track but restricted from any other motion. The first track being arranged to cause the outer cage to pivot during coupling and during uncoupling, the first track is required to raise and to lower the first follower. Suitably, the first track is delimited from below and from above by a suitably rigid structure.

The first track 250 comprises the first section 252 and the second section 254. As was explained above, the first follower 244 is displaceable along the first section 252 of the track to pivot the outer cage, and is displaceable along a second section of the first track to shift the outer cage parallel to the coupling axis.

Suitably, during insertion of the male coupling member 100 the outer cage 240 is brought into its closed configuration before fluid may egress from or into the second exit aperture 222. Accordingly, the first section 252 of the track has a length which, when projected onto the coupling axis A:A, is equal to or greater than the separation between the distal sealing ring 234 and the second exit aperture 222 when the piston 230 is in its closed position. Thereby it is ensured that the distal sealing ring reaches the second exit aperture once the outer cage was brought into its closed configuration.

Suitably, the first section 252 and the second section 254 are arranged in a V-shape. The second section extends parallel to the coupling axis and the first section at an angle thereto.

It is envisaged that alternatively the follower may be formed in the housing 260 or other rigid structure and the track 250 is formed in the outer cage 240.

In this example, an alignment track 270 is provided which is arranged to guide the male coupling member into the coupled configuration. Suitably, the alignment track is formed in the housing 260.

The alignment track 270 is generally straight and extends parallel to the coupling axis. Towards a distal end of the housing, the alignment track widens where a mouth is formed. Conveniently, insertion of the male coupling member 100 into the mouth of the alignment track may ease coupling of the valve assembly 10.

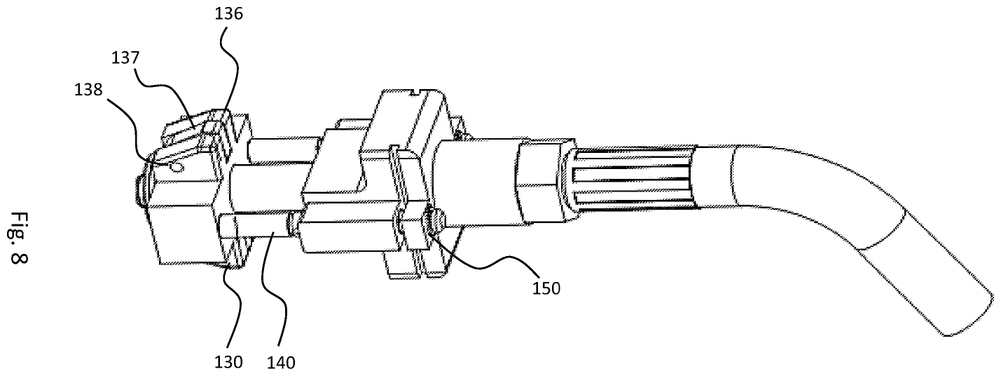

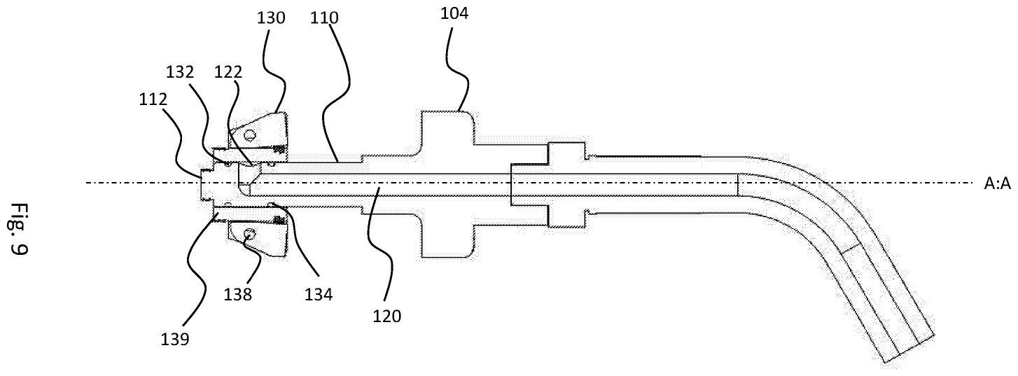

FIGS. 8 and 9 show the male coupling member 100. FIG. 8 is a perspective side view of the male coupling member, while FIG. 9 is a cut-away side view of the male coupling member.

The probe 110 extends from the main body 102 along a first direction which is collinear with the coupling axis A:A. The first direction corresponds to the coupling direction, while the opposite corresponds to the uncoupling direction.

The sheath 130 is moveable between its open position and its closed position through displacement along the coupling axis A:A. When in the closed position, fluid flow through the first exit aperture 122 is hindered. Suitably, a pair of sealing rings 132, 134 is provided in annular grooves extending circumferentially about the probe 110. A distal sealing ring 132 is located on a distal side of the first exit aperture 122, while a proximal sealing ring 134 is located on a proximal side of the first exit aperture. Thus, when the sheath 130 is in its closed position, the pair of sealing rings engages the sheath and prevents fluid flow through the first exit aperture.

Moving the sheath 130 towards the proximal end of the probe 110 brings the sheath 132 towards the open position. In doing so, the sheath successively exposes the distal sealing ring 132, the first exit aperture 122 and the proximal sealing ring 134. Ultimately, the sheath is brought into abutment with the main body 102.

The sheath 130 is arranged on a probe 110 having a substantially cylindrical shape. A shaft 140, or peg or rail, is arranged to retain the sheath 130 in a fixed orientation relative to the probe. The shaft extends from a proximal end of the sheath. Suitably, the shaft is received by a passage 150 formed in the main body 102 of the male coupling member 100. The shaft and the passage are arranged to cooperate to prevent the sheath from rotating about the probe. Suitably, the passage extends along a direction which is parallel to the coupling axis so that, in use, as the sheath is moved towards an open position the shaft is moved in the passage. That is, the shaft is moveable with the sheath, and arranged to move inside the passage.

In this example, the shaft 140 is arranged to prevent removal of the sheath 130 from the probe and, thus, define an extremal position of the sheath. In the extremal position, the distal end face of the sheath may be substantially aligned with the distal end face of the probe 110.

Suitably, the shaft is retained by the passage 150 and cannot be removed fully from the passage. An abutment member, e.g. a pin, is arranged to prevent the shaft from leaving the passage. Accordingly, the passage may be open-ended and a proximal end of the shaft is provided with the abutment member.

Thereby removal of the sheath 130 from the probe 110 may be prevented as the abutment member engages the body 102 and retains the sheath in an extremal position. The sheath may be in both the extremal position and in its closed position. In this example, the sheath is in its closed position whenever the sheath is in the extremal position.

In this example, the shaft 140 and the passage 150 are arranged to hinder the sheath 130 from leaving its closed configuration. Suitably, the shaft and the passage are configured to provide resistance which must be overcome for the sheath to move away from the closed configuration. Any suitable arrangement of shaft and passage may be used. For example, a resilient member such as a bracket may engage a groove formed in the shaft as the shaft is moved relative to the bracket.

The shaft 140 is offset relative to the coupling axis along a second direction, which is perpendicular to the first direction and the coupling axis A:A. In this example, a pair of shafts is provided on opposite sides of the sheath, being offset along opposite directions.

An inner shoulder 135 extends from the sheath 130. The shoulder extends along a third direction, which is perpendicular to the first direction and the second direction. In this example, a pair of shoulders is provided, the shoulders extending into opposite directions.

In this example, the shoulder 135 is arranged to aid insertion of the male coupling member 100. Suitably, the shoulder has a smaller extent towards the distal end of the sheath. In this example, the shoulder is chamfered. In this example, a pair of chamfered shoulders 135 is arranged on the sheath, the chamfered shoulders extending into opposite directions.

During uncoupling, as the male coupling member 100 is withdrawn from the female coupling member 200, the sheath 130 is retained in position by the inner cage 280. This causes the probe 110 to move relative to the sheath until the first exit aperture 122 is shut off by the sheath. This may not, however, ensure that the sheath is located at the distal end of the probe in an extremal position. Suitably, the sheath comprises a wing 136 arranged to ensure that the sheath is returned to the extremal position when the coupling members are being decoupled.

The wing 136 may be brought into an extended configuration and into a retracted configuration.

When the wing 136 is in the extended configuration, the sheath is arranged to resist removal of the sheath until the sheath and the probe have moved relative to each other so that the sheath is located in the extremal position. The wing 136 is arranged to then move into a retracted configuration in which to enable removal of the sheath along with the probe from the inner cage.

Suitably, the wing 136 extends from the inner shoulder through an opening formed in the inner shoulder. In this example, the wing is mounted in a channel and extends therefrom. Conveniently, the opening of the channel points into a direction away from the sheath. Thus the profile or cross-sectional size of the sheath may be suitably changed by extending or retracting the wing. Conveniently, in this example the opening of the channel points into a radial direction away from the coupling axis.

When in the extended configuration, the wing 136 extends from the channel a greater distance than when in the retracted configuration. In some examples, the wing may be retracted completely into the channel.

Accordingly, in the extended configuration the sheath possesses a larger profile than when in the retracted configuration. The sheath will therefore resist removal from the inner cage during uncoupling while the inner cage first engages the inner shoulder and then engages the wing 136. In some examples, the wing causes the sheath to be retained by the inner cage even where the inner cage has fully opened.

Once the sheath has reached its extremal position relative to the probe, the sheath is prevented from remaining in the inner cage. Suitably, the pair of shafts carrying the sheath are arranged to prevent further displacement of the sheath. That is, the shafts are arranged to retain the sheath in the extremal position and prevent the sheath from being removed from the probe. Accordingly, when the sheath is in the extremal position it will be moved along with the probe, because the shafts prevent further relative displacement.

Suitably, when the sheath is in the extremal position, urging the male coupling member to uncouple causes the wing 136 to retract. That is, the wing is urged to move from the extended configuration to the retracted configuration. During uncoupling, the inner crossbar of the inner cage suitably engages the wing and urges the wing into the retracted configuration.

Conveniently, the wing 136 is arranged to return to the extended configuration. Any suitable means for biasing the wing may be used. In this example, the wing is sprung. That is, a resiliently deformable biasing member 137 is arranged to bias the wing. The biasing member may be, for example, a spring such as a helical spring.

In this example, the wing 136 is pivotally arranged about a wing pivot 138 defining a pivot axis. Suitably, the biasing member 137 causes the wing to pivot about the pivot axis. Thereby the biasing member may return the wing to the extended configuration.

With the wing 136 being biased towards the extended configuration, the wing may catch the inner cage during coupling. This may not, however, cause the sheath 130 to be moved from its closed position to an open position. Instead, the shaft is suitably arranged to resist displacement of the sheath from the closed position. Only once the sheath abuts the socket a force large enough to overcome the resistance of the shaft so as to move the sheath relative to the probe. Accordingly, the sheath may push past the inner cage on entry, but is arranged to resist moving past the inner cage on exit. The sheath and the inner cage are therefore arranged to act comparable to a door fitted with a latch, in that the door may be shut but the latch will hinder opening of the door once is has been shut.

In some examples, the sheath comprises a plurality of wings 136. In this example, the sheath comprises a pair of wings arranged on opposite sides, each wing mounted to an inner shoulder 135.

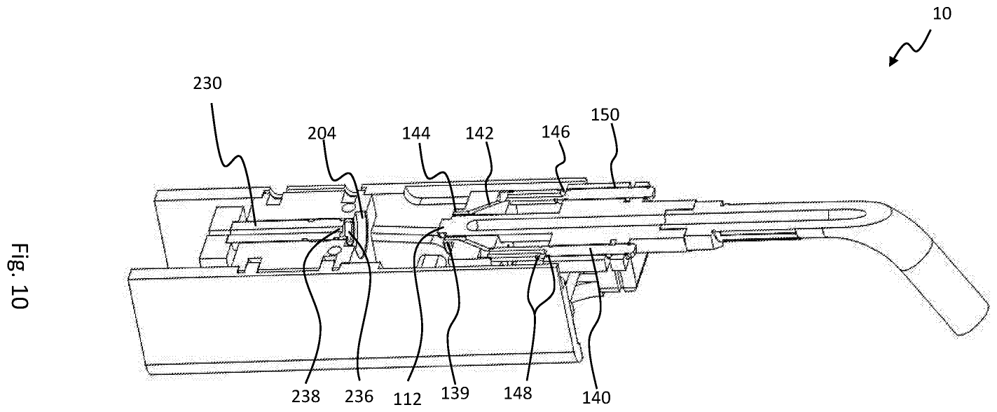

FIG. 10 is a perspective, cut-away top view of the coupling assembly 10 in a partially coupled arrangement. The male coupling member 100 is inserted into the female coupling member 200 with the probe 110 still separated from the socket 210. In the partially coupled arrangement, the fluid passageways are not opened.

In this example, the body 202 of the female coupling member 200 forms a first recess 204 in which the socket 210 is accessed. For coupling, the sheath 130, which is in its closed position, is inserted into the recess. Suitably, the sheath comprises a sheath projection 139 arranged to fit into the first recess. In this example, the first recess is annular and, thus, the sheath projection 139 is annular to fit the first recess and extend about the probe 110. However, any suitable matching shapes may be chosen and in other examples, different matching shapes are chosen such as oval or polygonal.

The sheath projection 139 is arranged to form a seal with the first recess 204. Suitably, the sheath projection forms a groove on an outer face in which an O-ring is carried. Conveniently, the O-ring is arranged to seal the gap between the sheath projection 139 and the portion of the socket 210 which forms the first recess.

As the sheath projection 139 is inserted into the first recess 204, fluid may be trapped in the first recess. Conveniently, a first drainage aperture is formed in the distal end face of the sheath projection 139 so that any fluid trapped in the first recess may flow into the first drainage aperture. Suitably, the first drainage aperture connects to a drainage passage 142 extending through the sheath. The drainage passage extends through the sheath and, in particular, through the shaft 140 to a second drainage aperture 146. Utilising the drainage passage, any fluid trapped in the first recess can escape.

The second drainage aperture 146 may be formed in any portion of the shaft. In this example, the shaft has a generally cylindrical shape and the second drainage aperture is formed by the radial surface of the shaft. That is, the second drainage aperture defines an opening in the shaft which points into a radial direction.

In this example, the second drainage aperture 146 is located on a section of the shaft 140 which is open when the sheath 130 is in its open position. As the sheath is moved towards its closed position, the second drainage aperture is moved inside the passage 150 and sealed. Suitably, a pair of O-ring seals 148 carried by the shaft and is located about the second drainage aperture. Thus, the O-rings are arranged to seal the second drainage aperture inside the passage. Conveniently, the second drainage aperture is sealed once the first recess 204 is drained. Suitably, the second drainage aperture is located in the vicinity of the passage when the sheath is in the open position. Thereby leakage from the fluid passageways 120, 220 may be reduced and pollution prevented. In this example, a proximal O-ring of the pair of O-rings is located inside the passage when the sheath 130 is in the closed position.

In some examples, a plurality of drainage channels is formed. In this example a pair of drainage channels is formed, each having a drainage aperture in the sheath projection 139.

In this example, the piston 230 forms a second recess 236. A projection 112 extending from the distal end of the probe 110 is arranged to fit into the second recess. In this example, the second recess is circular and, thus, the projection 112 is arranged circularly to fit the second recess. However, any suitable geometric shape may be chosen and in other examples different matching shapes are chosen.

The projection 112 is arranged to form a seal with the piston 230 when inserted into the second recess 236. In this example, the projection forms a groove in which an O-ring is located. In use, the O-ring seals the gap between the projection and the portion of the piston which forms the second recess 236.

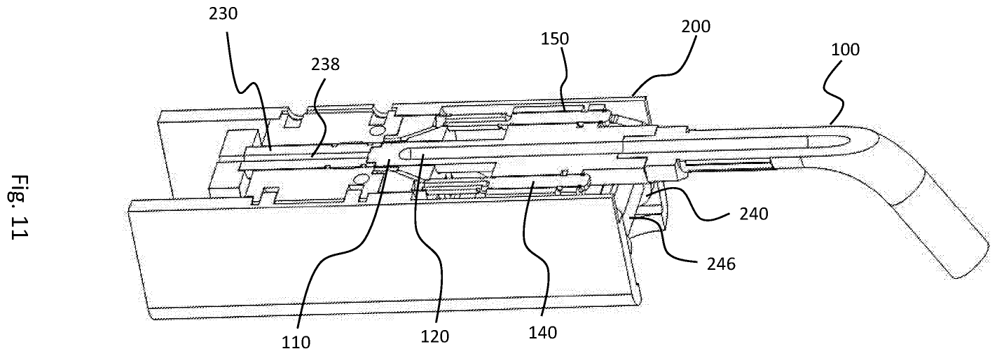

FIG. 11 is a perspective, cut-away top view of the coupling assembly 10 in a partially coupled arrangement. The male coupling member 100 has been inserted into the female coupling member 200, bringing the probe 110 and the piston 230 into abutment.

As the probe 110 is brought into abutment with the piston 230, fluid may be trapped in the second recess 236. Conveniently, a second drainage aperture is formed in the second recess 236. Suitably, the second drainage aperture communicates with a second drainage passage 238. The second drainage passage extends through the piston 230. Utilising the second drainage passage, any fluid trapped in the second recess can escape.

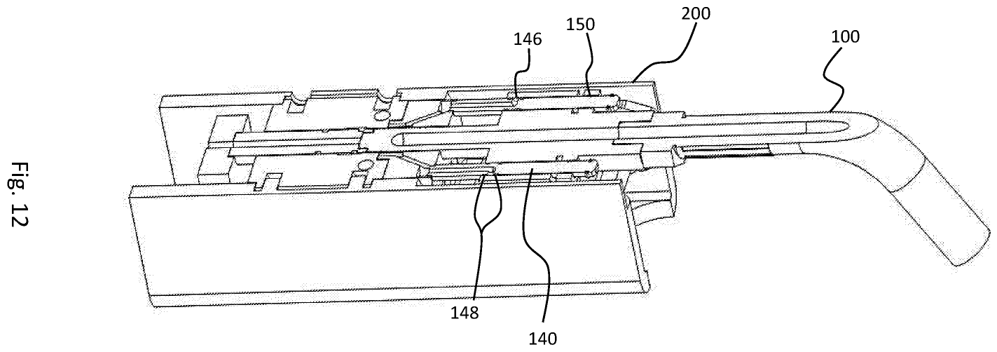

FIG. 12 is a perspective, cut-away top view of the coupling assembly 10 in a partially coupled arrangement. The probe 110 has been inserted into the socket 210, partially displacing the piston 230.

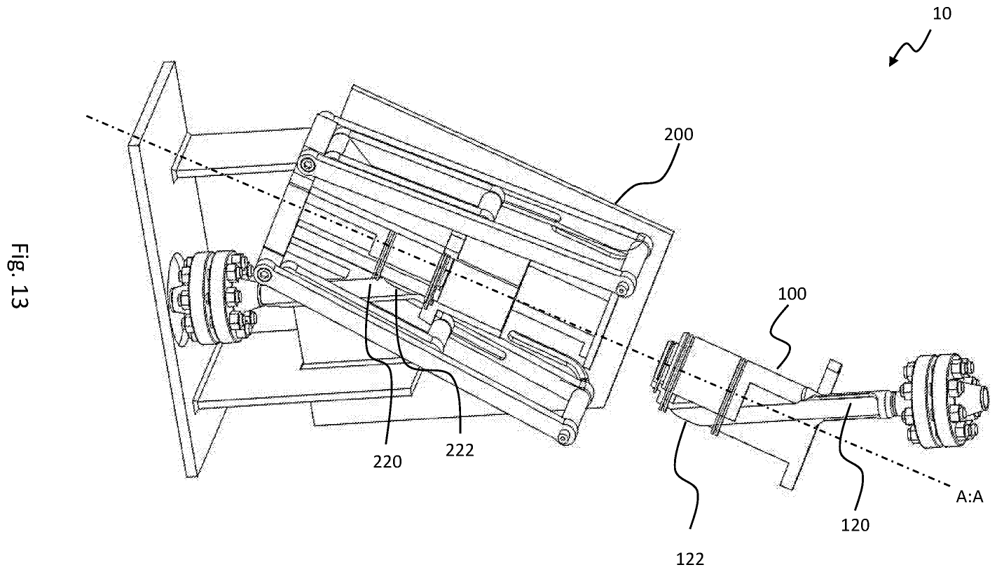

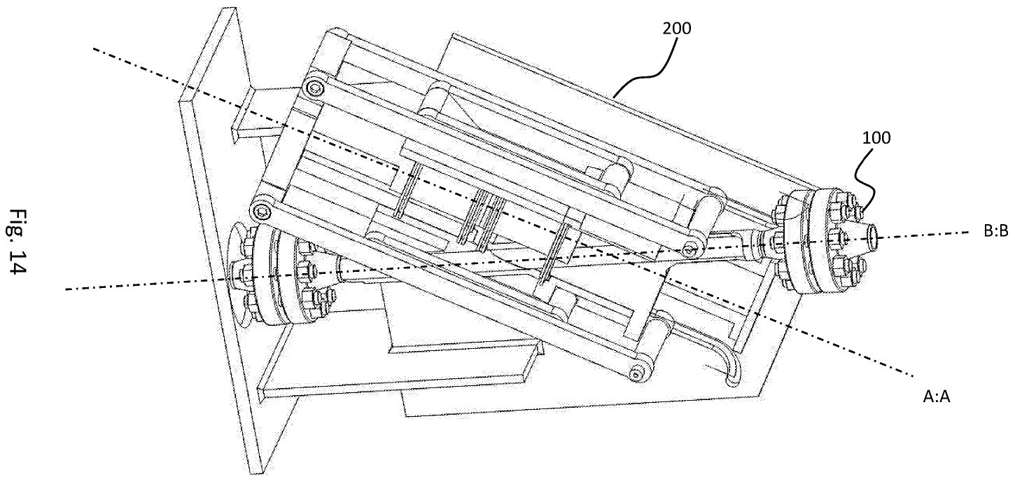

In this example, the male coupling member 100 and female coupling member 200 are symmetrical about a plane in which the coupling axis A:A lies, and which is perpendicular to the first pivot axis. FIGS. 13 and 14 illustrate an example coupling assembly 10 where the male coupling member and the female coupling member do not possess this symmetry.

FIGS. 13 and 14 show a partially cut-away perspective view of coupling assembly 10. FIG. 13 shows the coupling assembly in an uncoupled arrangement, while FIG. 14 shows the coupling assembly in a coupled arrangement.

The coupling assembly 10 is generally alike to the coupling assembly discussed with reference to FIGS. 1-12, and a detailed description of features already discussed is therefore omitted.

The coupling assembly 10 includes a male coupling member 100 with a probe 110 arranged to couple to a female coupling member 200 along a coupling axis A:A.

A first fluid passageway 120 extends through the male coupling member 100. In this example, the entire first fluid passageway extends at an angle to the coupling axis A:A. Suitably, this angle is larger than 0° (degrees) and smaller than 90°. In some examples, the angle may be between 10° and 60°. In other examples, the angle may lie between 15° and 45°. In yet further examples, the angle may lie between 25° and 35°. By contrast, in the earlier example a section of the first fluid passageway extends collinearly with the coupling axis and smaller section is perpendicular to the coupling axis.

The female coupling member 200 forms a second fluid passageway 220. In this example, the second fluid passageway is not arranged collinearly with the coupling axis. The second fluid passageway is arranged so that the first fluid passageway 120 and the second fluid passageway may be brought into flow communication. Suitably, the second fluid passageway is at an angle to the coupling axis A:A.

In this example, the first and second fluid passageways are substantially straight. Additionally, the first and second fluid passageways are arranged to form a substantially straight combined fluid passageway when the coupling assembly 10 is brought into a coupled arrangement. The combined fluid passageway extends along an axis B:B. Conveniently, a straight fluid passageway may provide for easier access in order to perform inspection or maintenance, for example in the form of ‘pigging’. Notably, known ‘pigs’ may not be able to reach sections of a hose or pipeline which after a bend at a right angle.

In this example, a first track 250 is formed to have a first section 252 which is curved and a second section 254 which is straight. The first section may correspond to a quarter of a circle or ellipse.

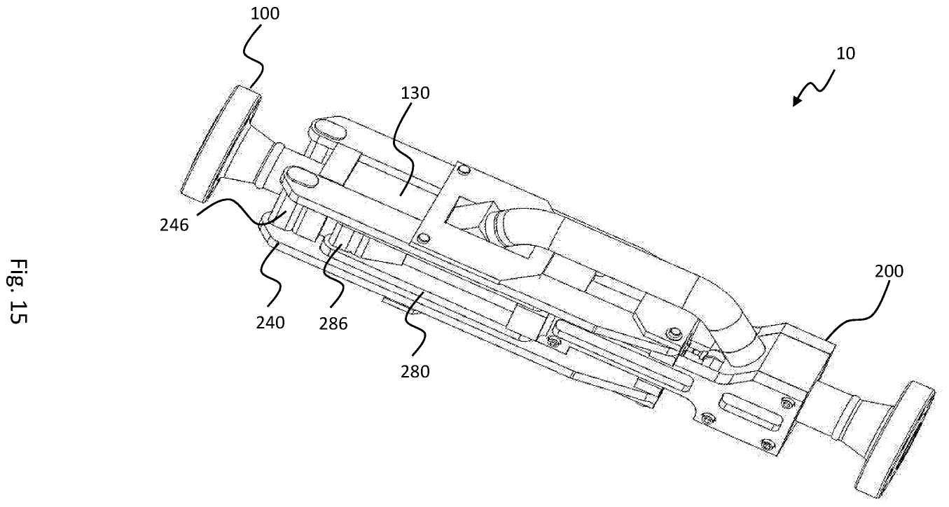

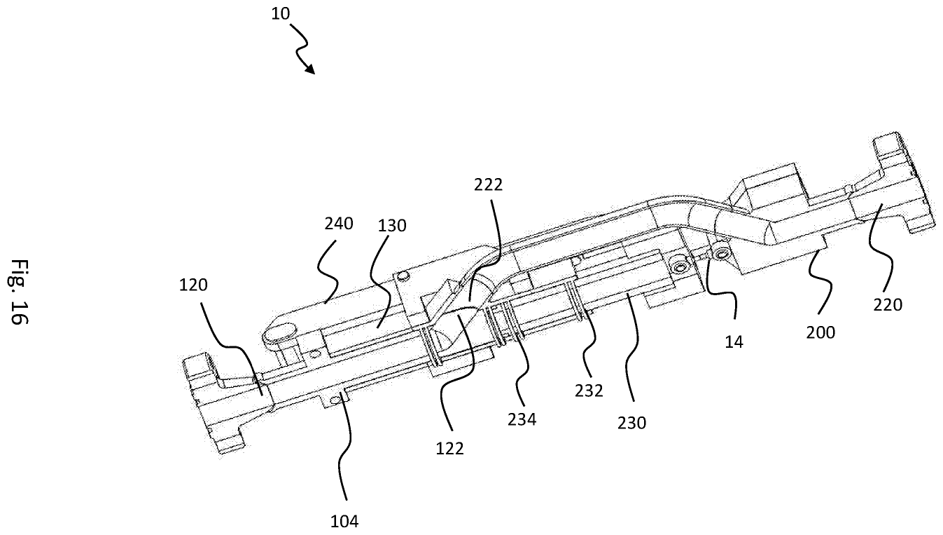

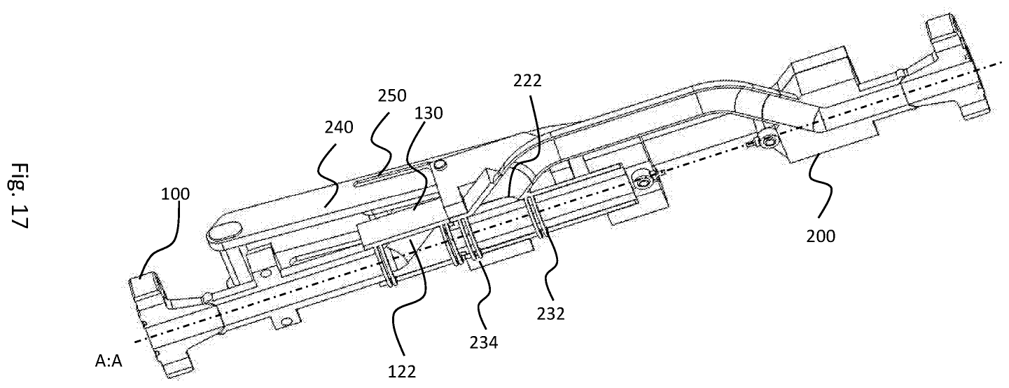

FIGS. 15, 16 and 17 show another example application of a coupling assembly 10.

In this example, the coupling assembly is arranged as a mid line weak link. That is, the coupling assembly 10 is in use positioned midway along a fluid-carrying hose and configured to decouple in an emergency and to automatically shut off fluid flow.

A mid line weak link is arranged to protect personnel and equipment against an uncontrolled uncoupling. Known mind line weak links, however, may be difficult to actuate and may cause substantial fluid loss in the case of a decoupling.

Suitably, the coupling assembly 10 is arranged for improved actuation and reduced fluid loss in the event of a decoupling.

The coupling assembly 10 is generally alike to the coupling assembly discussed with reference to earlier Figures, and a detailed description of features already discussed is therefore omitted.

The coupling assembly 10 comprises a tension pin 14 which is arranged to break in response to an external separation force acting on the coupling assembly, as opposed to separation forces due to pressurised fluid flow inside the coupling assembly. That is, the tension pin is arranged to disconnect when a threshold tension on the coupling assembly is exceeded. In some examples, the tension pin is arranged to break upon the threshold tension being reached. Suitably, the tension pin extends along the coupling axis A:A.

The coupling assembly 10 comprises a male coupling member 100 and a female coupling member 200. The male coupling member 100 is received by the female coupling member 200 and retained against separation forces due to fluid flow inside the coupling assembly by a pair of cages 240, 280.

In this example, the outer cage forms a first track 250 while the follower is formed on the body 202 of the female coupling member, as opposed to earlier examples where the follower was formed on the cage and the track formed on body. Hence improved compactness of the coupling assembly 10 may be achieved, which may be particularly desirable for a mid line weak link but also outer applications for the coupling assembly.

In this example, the second fluid passageway 220 runs beside the tension pin 14, extending towards the coupling axis A:A to form a second exit aperture 222 which may be arranged to be in flow communication with a first exit aperture 122 of the male coupling member 100. This arrangement allows the tension pin 14 to extend collinearly with the coupling axis, thus improving the tension pin's response to external separation forces.

Notably, as the tension pin breaks and the coupling assembly uncouples, a sheath 130 closes the first exit aperture 122 of the male coupling assembly and a piston 230 closes the second exit aperture 222 of the female coupling member. Thereby loss of fluid in the event of a breaking may be minimised and pollution prevented.

In summary, exemplary embodiments of a valve assembly have been described. The described exemplary embodiments provide for an improved assembly.

The valve assembly may be manufactured industrially. An industrial application of the example embodiments will be clear from the discussion herein.

Although preferred embodiment(s) of the present invention have been shown and described, it will be appreciated by those skilled in the art that changes may be made without departing from the scope of the invention as defined in the claims.

1. A valve assembly having a male coupling member and a female coupling member,
the male coupling member comprising:
a probe for insertion along a coupling axis, and
a first fluid passageway having a first exit aperture on a side face of the probe; and
the female coupling member comprising:
a socket for receiving the probe of the male coupling member along the coupling axis,
a second fluid passageway having a second exit aperture on an internal side face of the socket,
a first closing member which is freely moveable between an open position in which the second exit aperture is at least partially unobstructed and a closed position in which the second exit aperture is fully obstructed,
a first securing member which is pivotally connected to a first pivot moveable with the closing member and defining a first pivot axis;
a first follower which is mounted to a first track and arranged to be displaced along the first track by the first securing member to cause the first securing member to pivot relative to the first closing member to releasably secure the first closing member to the probe such that the first closing member and the probe are restrained from moving relative to each other.

2. The valve assembly according to claim 1, the male coupling member including a second closing member arranged about the probe, wherein the second closing member is movable between an open position in which the second exit aperture is at least partially unobstructed and a closed position in which the second exit aperture is fully obstructed.

3. The valve assembly according to claim 2, the female coupling member comprising:
a second securing member which is pivotally connected to a second pivot defining a second pivot axis, and
a second follower which is mounted to a second track and arranged to be displaced along the second track by the first securing member to cause the second securing member to pivot relative to the socket to releasably secure the socket to the second closing member such that the socket and the second closing member are restrained from moving relative to each other.

4. The valve assembly according to claim 1, wherein the first follower is displaceable along a first section of the first track to pivot the first securing member, and wherein the first follower is displaceable along a second section of the first track to shift the first securing member parallel to the coupling axis.

5. The valve assembly according to claim 4, wherein the first and the second section of the first track are arranged in a V-shape.

6. The valve assembly according to claim 1, wherein the first follower is located on the first securing member and wherein the first track is formed in a housing of the female coupling member.

7. The valve assembly according to claim 1, wherein the first securing member is arranged to occupy a space which extends between the first pivot axis and an axis of rotation defined by the first follower.

8. The valve assembly according to claim 2, the male coupling member comprising:
a passage extending parallel to the coupling axis and arranged to receive a shaft,
the shaft arranged moveable with the second closing member and constrained to motion along the passage.

9. The valve assembly according to claim 8, the male coupling member comprising a third fluid passageway, the third fluid passageway extending between an exit aperture in a distal end face of the second closure member and exit aperture in the shaft.

10. The valve assembly according to claim 8, wherein the shaft is arranged to bias the second closure member to remain in the closed position in which the second exit aperture is fully obstructed.

11. The valve assembly according to claim 1,
the male coupling member comprising a projection on a distal end face of the probe;
the female coupling member comprising a recess formed in a distal end face of the first closure member and arranged to receive the projection of the probe.

12. The valve assembly according to claim 11, the female coupling member comprising a fourth fluid passageway having a fourth exit aperture in the recess of the first closure member; the fourth fluid passageway extending through the first closure member.

13. The valve assembly according to claim 1, the second closing member comprising a latch moveable between an extended configuration and a retracted configuration, the latch being biased towards the extended configuration in which the latch is arranged to engage the female member during uncoupling, the latch being arranged to move to the retracted configuration as the second closing member is urged against the female member during uncoupling, and the second closing member being removable from the female member when the latch is in the retracted configuration.

14. A female member for use with a male coupling member in a valve assembly, the female coupling member comprising:
a socket for receiving a probe of said male coupling member along a coupling axis;
a second fluid passageway having a second exit aperture on an internal side face of the socket;
a first closing member which is freely moveable between an open position in which the second exit aperture is at least partially unobstructed and a closed position in which the second exit aperture is fully obstructed;
a first securing member which is pivotally connected to a first moveable with the closing member and defining a first pivot axis;
a first follower which is mounted to a first track and arranged to be displaced along the first track to cause the first securing member to pivot relative to the first closing member.

15. A method of releasably interconnecting a male coupling member and a female coupling member of a valve assembly, wherein the method comprises:
inserting a probe of the male member into a socket of the female member, the probe including a first fluid passageway having a first exit aperture on a side face of the socket,
the socket including a second fluid passageway having a second exit aperture on an internal side face of the socket;
displacing a first closing member which is moveable between an open position in which the first exit aperture is at least partially unobstructed and a closed position in which the exit aperture is fully obstructed;
causing a displacement of a first securing member, the first securing member being pivotally connected to a first pivot moveable with the first closing member and defining a first pivot axis;
causing a follower mounted to a first track to be displaced along the first track to cause pivoting of the first securing member relative to the first closing member to releasably secure the closing member to the probe such that the first closing member and the probe are restrained from moving relative to each other.

16. A male coupling member use with a female coupling member in a coupling assembly, as claimed in claim 1.
